(19) United States
(12) Patent Application Publication
(10) Pub. No.: US 2015/0264959 A1
(43) Pub. Date: Sep. 24, 2015

(54) APPARATUS AND METHOD FOR DISPENSING SHAVED FROZEN PRODUCTS

(71) Applicant: CORPORATE GROWTH AND DEVELOPMENT INC. DBA FRUKT SNO, Kitchener (CA)

(72) Inventors: Scott Colwell, Kitchener (CA); Richard Dobrowney, Mannheim (CA)

(21) Appl. No.: 14/434,905

(22) PCT Filed: Oct. 15, 2013
(86) PCT No.: PCT/CA2013/050781

§ 371 Date: Apr. 10, 2015

Related U.S. Application Data
(60) Provisional application No. 61/713,041, filed on Oct. 12, 2012.

(51) Int. Cl. A23G 9/28; A23G 9/04

(52) U.S. Cl. CPC A23G 9/28; A23G 9/045

(57) ABSTRACT

An apparatus for dispensing shaved frozen products and a method for storing and dispensing frozen products are provided. The apparatus for dispensing shaved frozen product includes: a dispensing area; and a refrigerated area having: a plurality of shaving units; and a platform, operatively connected to each of the plurality of shaving units and configured to allow each shaving unit to rotate. The method for dispensing frozen products includes: providing a plurality of frozen blocks to a plurality of shaving units; selecting at least one of the frozen blocks to be shaved; rotating a carousel to align a shaving unit of the plurality of shaving units with a dispensing area; and dispensing a predetermined portion of the selected frozen block.

### CROSS REFERENCE TO RELATED APPLICATIONS

This application claims the benefit of priority of U.S. Provisional Patent Application No. 61/713,041 filed Oct. 12, 2012, which is incorporated herein by reference in its entirety.

### FIELD

The present disclosure relates generally to frozen products. More particularly, the present disclosure relates to apparatus and method for dispensing shaved frozen products or desserts.

### BACKGROUND

Ice and snow based confectionaries have long been eaten as a refreshing delicacy. Within this segment of confectionaries are ice cream, snow cones, slushies and shaved ice. This segment of confectionaries also includes treats shaved from a frozen block, commonly known as ‘shaved snow.’ Conventionally, frozen block machines make the shaved snow type of confection by shaving long ribbons (sometimes described as having a cotton-candy like texture) off of a frozen block of product. These machines typically involve placing a frozen block in a hopper and then, using a manual or motor mechanism, rotate the frozen block against the blade to produce the shaved ribbon of ice. Typically, the frozen blocks of product will include dairy or non-dairy creamer to achieve the desired consistency and may also include one or more flavorings. In some cases, flavorings (or additional flavorings) may be applied to the shaved snow after it is shaved from the frozen block.

However, conventional frozen block machines are unable to provide multiple flavors and controlled portion size shaved snow products. Conventional frozen block machines are usually only able to contain and shave one frozen block at a time. Additionally, conventional machines require the operator to load a new frozen block into the shaver every time a different frozen block is desired, for example, for dairy or non-dairy or differing flavors or the like. Further, when flavored blocks are used, the flavored frozen block must be returned to a freezer after the serving is shaved in order to avoid melting and/or comply with food sanitation requirements.

Typically, every time a different frozen block is used it may be necessary to clean the blade and base assembly in order to ensure that there is not a mix of different products. This can be particularly important when dealing with food allergies, such as an allergy to dairy products. Furthermore, cleaning of conventional machines can be an issue, particularly when the frozen blocks contain dairy products.

It is, therefore, desirable to provide an apparatus and method for dispensing shaved frozen products which is intended to address at least one of the disadvantages of conventional frozen block machines.

### SUMMARY

In a first aspect, the present disclosure provides an apparatus for dispensing shaved frozen product including: a dispensing area; and a refrigerated area having: a plurality of shaving units; and a platform, operatively connected to each of the plurality of shaving units and configured to allow each shaving unit to rotate.

In a particular case, the apparatus may include a cover comprising a plurality of user selection input options.

In another particular case, the apparatus may further include: an electronic area having at least one drive shaft configured to connect to at least one shaving unit of the plurality of shaving units; and at least one motor operatively connected to the at least one drive shaft and configured to rotate the shaving unit to shave the frozen product. In some cases the refrigerated area and the electronic area may be distinct areas within the apparatus.

In still another particular case, each shaving unit may include: a top plate; a lower shaver plate; and a hopper located between the top plate and lower shaver plate.

In yet another particular case, the top plate may include a plurality of pins configured to grip the frozen product.

In still yet another particular case each shaving unit may include a lower shaver plate comprising a blade assembly.

In a particular case, the blade assembly may include a removably attached blade.

In another particular case, the blade assembly may slidably slot on the lower shaver plate having a clamping mechanism configured to lock the blade assembly in place.

In still another particular case, the blade assembly may include a heat treated blade.

In still yet another particular case, the platform may be a carousel configured to rotate the plurality of shaving units.

In a further aspect, there is provided a method for storing a shaved frozen product including: providing a plurality of frozen blocks to a plurality of shaving units; and regulating the temperature within a refrigerated component housing the plurality of shaving units.

In a particular case, the method may also include: determining whether the regulated temperature is outside of a predetermined threshold; and if the temperature is outside of the predetermined threshold, providing an alert, otherwise continuing to regulate the temperature.

In a further embodiment, there is provided a method for dispensing a shaved frozen product including: providing a plurality of frozen blocks to a plurality of shaving units; selecting at least one of the frozen blocks to be shaved; rotating a carousel to align a shaving unit of the plurality of shaving units with a dispensing area; and dispensing a predetermined portion of the selected frozen block.

In a particular case, dispensing a predetermined portion of selected frozen block may include shaving the frozen block.

In another particular case, a predetermined portion may be based on a predetermined duration of shaving or a predetermined number of revolutions of the frozen block within the shaving unit.

In still another particular case, selecting at least one of the frozen blocks to be shaved may include, selecting a plurality of frozen blocks to be shaved; and dispensing a predetermined portion of the selected frozen block may include, dispensing a predetermined portion of each of the selected frozen blocks.

In still yet another particular case, the method may further include: determining the amount of frozen block within each shaving unit; and issuing an alert if the amount of frozen block is below a predetermined threshold.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a front-side perspective view of an embodiment of an apparatus for dispensing shaved frozen products;

FIG. 2 is a front-side perspective view of an another embodiment of an apparatus for dispensing shaved frozen products;

FIG. 3 is a perspective view of a dispensing area according to an embodiment of an apparatus for dispensing shaved frozen products;

FIG. 4 is a sectional close-up view of a lower portion of an embodiment of an apparatus for dispensing shaved frozen products;

FIG. 5 is a perspective view of a single frozen block shaving unit;

FIG. 6 is a perspective view of a shaving area of a frozen block shaving unit;

FIG. 7A is a perspective view of a lower shaver plate of a shaving unit;

FIG. 7B is a perspective view of a lower shaver plate with a blade assembly removed;

FIG. 8 is an exploded perspective view of an example blade assembly;

FIG. 9 illustrates a method for storing and dispensing shaved frozen products;

FIG. 10 illustrates a front-side view of an apparatus for a dispensing shaved frozen products according to another embodiment;

FIG. 11 illustrates a front perspective view of an apparatus for dispensing shaved frozen products according to the embodiment of FIG. 10;

FIGS. 12A and 12B illustrate a side and front of an apparatus for dispensing shaved frozen products according to the embodiment of FIG. 10;

FIG. 13 illustrates a front perspective view of an apparatus for a dispensing shaved frozen products according to another embodiment;

FIG. 14 illustrates a front view of an apparatus for dispensing shaved frozen products according to the embodiment of FIG. 13;

FIG. 15 illustrates a back view of an apparatus for dispensing shaved frozen products according to the embodiment of FIG. 13;

FIGS. 16 to 25 illustrate electronic circuits and controls for an apparatus for dispensing shaved frozen products

FIG. 26 illustrates an apparatus for dispensing shaved frozen products according to another embodiment;

FIG. 27 illustrates a front perspective view of an apparatus for dispensing shaved frozen products according to the embodiment of FIG. 26; and

FIGS. 28A and 28b illustrates an exploded view of the shaving units and platform according to the embodiment of FIG. 26.

### DETAILED DESCRIPTION

Generally, the present disclosure relates to an apparatus and method for dispensing shaved frozen products. The apparatus is intended to be capable of holding multiple frozen blocks and keeping the frozen blocks at an appropriate temperature to allow easy and efficient dispensing of a plurality of frozen blocks over an extended period of time. It will be understood that although the shape of the frozen product prior to being shaved is referred to as a block, the shape may vary depending on the shape of the container used to freeze the product prior to being shaved. In some cases, the shaved block may be a cylindrical shape, a cubic shape, or the like. It will be further understood that although the apparatus and method are sometimes referred to as an apparatus or method for dispensing frozen desserts, the dispensed frozen product is not limited to desserts or traditional dessert flavors and may further dispense savory flavors or palate cleansers.

In particular, an example embodiment of an apparatus for dispensing frozen products includes a plurality of shaving units or sub-assemblies each configured to hold a frozen block and dispense the shaved frozen block product into one or more receivers. For example, the apparatus may select from a plurality of pre-loaded frozen blocks to be dispensed by a shaving unit or may allow for dispensing of a plurality of pre-loaded frozen blocks at a plurality of dispensing areas.

The apparatus is intended to produce a shaved product with a snow-like texture from frozen blocks that may be composed of, for example, pure ice, flavorings, dairy, or non-dairy. The apparatus may be configured to allow for shavings or “ribbons” with varying thickness and which allow for a snow-like texture.

In some cases, the apparatus may include user selection buttons located on the front of the apparatus which are intended to provide a convenient selection mechanism for a specific flavor to be dispensed. The user selection feature allows a user to select one of a plurality of pre-loaded frozen blocks. The user selection allows a user to select from a variety of flavors which will be automatically dispensed. In other cases, the user selection may be made through other input options, for example, a mechanical switch, communicated over a computer network, by manually moving a platform or carousel located within the apparatus, or the like.

The user selection feature may also allow the user to select a serving size. The choice of serving size may be, for example, pre-programmed (locked) or user selected (unlocked). The apparatus may also include a payment feature such that the user can pay for the shaved frozen block product at the apparatus in a similar way to vending machines. The user selection feature may also be configured to allow the user to request the apparatus to dispense a plurality of servings. In some cases, the user selection feature may also be configured or programmed to allow the user to select the thickness, texture, or the like of the shaved frozen block product.

It will be understood that various configurations of the apparatus can be provided that are adapted for retail sales use, self-serve retail use, commercial kitchen use or the like. In some cases, the apparatus may be specifically adapted for commercial kitchen use. In other cases, the apparatus may be adapted for convenience store use of fast food dispensing use.

In some cases, the apparatus may include a frozen block shaving speed control. The shaving speed control may be programmed by, for example, factory settings, the user, the apparatus's owner or technician, or the like.

The apparatus is configured to store the at least one frozen block at a desired storage temperature and humidity, thus not requiring the blocks to be removed for storage when the apparatus is not in use. In particular, it is intended that the apparatus maintains the desired temperature in both frozen block storage areas and dispensing areas. The temperature is intended to be maintained both while the apparatus is in active dispensing mode and while the apparatus is idle waiting for input. The desired temperature may be set to a fixed temperature or may be held within a range of temperatures as appropriate for food sanitation requirements, maintaining consistency of the frozen block, or the like. In some cases, the apparatus may include a compartment for additional cold storage of replacement blocks.

In some cases, the apparatus may include a warning system to alert a user or an operator that the quantity of at least one of the frozen blocks is low or finished or if there is an issue with temperature or humidity in the storage compartment or the like. The warning may be, for example, an exterior light, a displayed message, a sound emitted through a speaker in the apparatus, or the like, a combination of the possible warnings. In other cases, the apparatus may notify an operator via a communication device, for example, over a pager, e-mail, text message or other form of communication.

A method to store and dispense shaved frozen products is further detailed herein. The method includes providing a plurality of frozen blocks in a refrigerated compartment, allowing selection of one of the plurality of frozen blocks and dispensing a predetermined portion of the selected one of the frozen blocks. The predetermined portion may be based on a predetermined duration of shaving, a predetermined number of revolutions of the shaving sub-assembly, a predetermined reduction of volume of the frozen block, or the like.

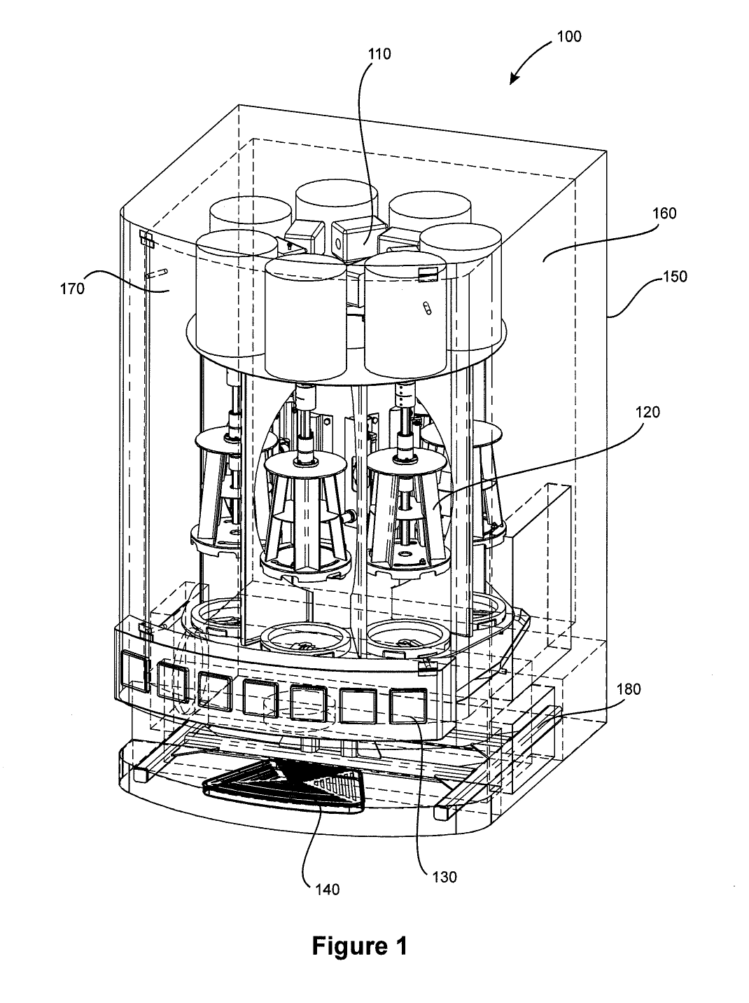

FIG. 1 is a front-side perspective view of an embodiment of an apparatus for dispensing shaved products 100. The apparatus includes a platform or carousel 110 arrangement that includes a plurality of frozen block shaving units 120, sometimes referred to as shaving sub-assemblies. Frozen blocks are loaded into the shaving units 120 and remain in position during dispensing as well as for storage purposes. The apparatus 100 is configured to allow the frozen blocks to remain in the shaving units 120 due to the refrigeration of the interior of the apparatus 100 to provide appropriate temperature and humidity levels for storage of the frozen blocks. The refrigeration may be accomplished using cold plates, forced air or the like.

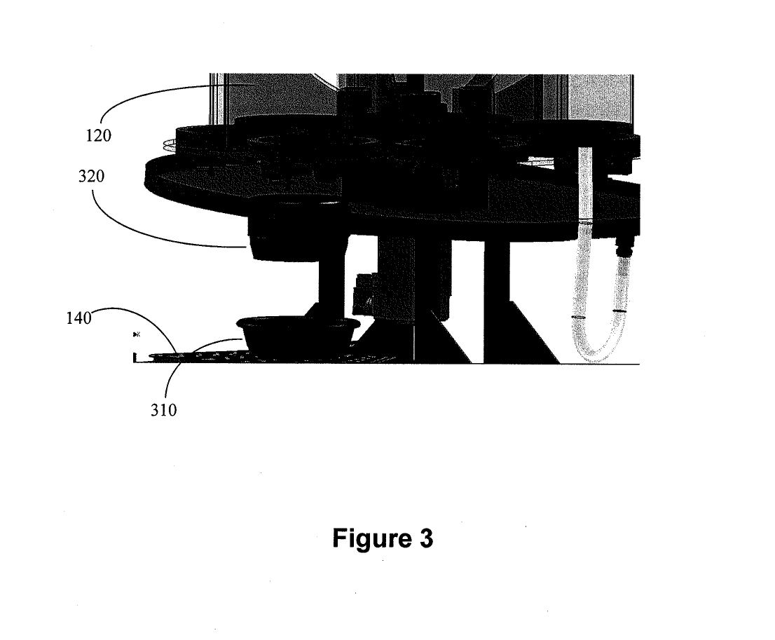

The apparatus 100 may include front-mounted user selection buttons 130, as well as a dispensing tray 140 for holding a receptacle (shown in FIG. 3) designed to receive the dispensed shaved frozen block product. In this example embodiment, the frozen block shaving units 120 have a modular design that is intended to facilitate cleaning and maintenance. This modular design is intended to allow for the parts of the frozen block shaving unit 120 to be easily removed or replaced in order to provide ease and speed in the cleaning and repair of the apparatus 100. It will be understood that other arrangements of the frozen block shaving units 120 may also be provided in addition to the illustrated carousel structure, for example, in-line, stacked, laid flat, crescent shaped, or the like. In some configurations or arrangements, the apparatus may include more than one dispensing tray or dispensing area.

The apparatus 100 includes a cover 150 designed to cover an internal component 160. The internal component 160 is intended to not only protect the internal mechanisms of the apparatus 100 but also is intended to provide further insulation for the refrigeration of the apparatus 100. The apparatus 100 may further include a display area 170. The display area 170 may be used as advertisement space, to inform the users of the flavors available, to instruct the users with respect to the available user selections, or the like. In some cases, the display area 170 may be a computerized display area or screen. The apparatus 100 further includes a support structure 180 designed to support the plurality of shaving units 120.

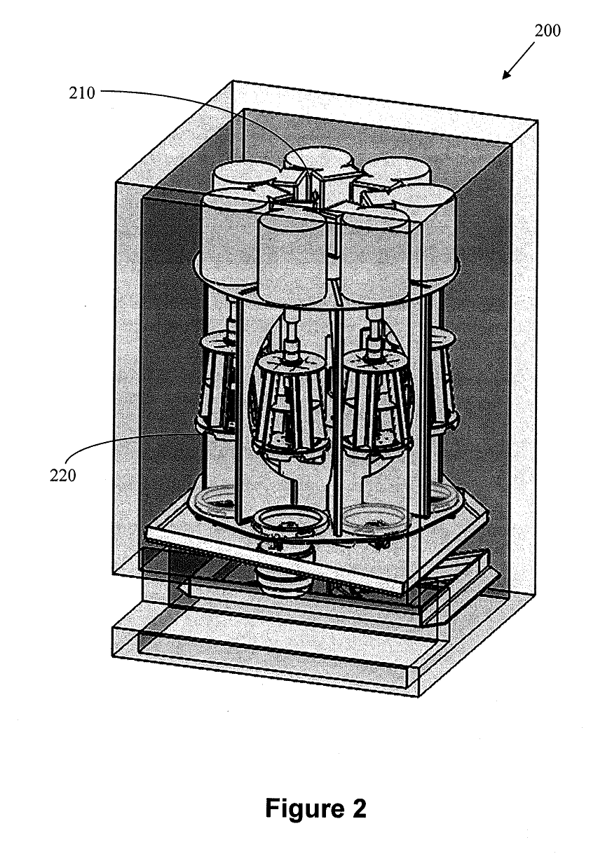

FIG. 2 illustrates a further embodiment of an apparatus for dispensing frozen shaved products 200. The apparatus 200 includes a carousel 210 having a plurality of shaving units 220. The embodiment illustrated in FIG. 2 may allow for user selection through other input features as opposed to user selection buttons 130, for example, over a computer connection or through a mechanical switch.

FIG. 3 illustrates a close-up perspective view of the dispensing area 140 of the apparatus 100. The dispensing area 140 includes a dispenser 320 configured to align with an opening of a shaving unit 120. A receptacle 310, for example a bowl, a cone, or the like, is placed in the dispensing area 140 in order to receive the shaved frozen block product. The shaved frozen block product, after being shaved in the frozen block shaving unit 120, enters the dispenser 320. The dispenser 320 funnels the shaved frozen block product into the bowl 310. The dispenser 320 or receptacle 310 may be automatically moved in order to guide the shaved frozen block product to evenly fill the receptacle 310. In some cases, a user may manually move the receptacle in order to receive an even fill. In some cases, the dispenser 320 may include a funnel that has an internal design that can guide the shaved frozen block product to evenly fill the receptacle 310

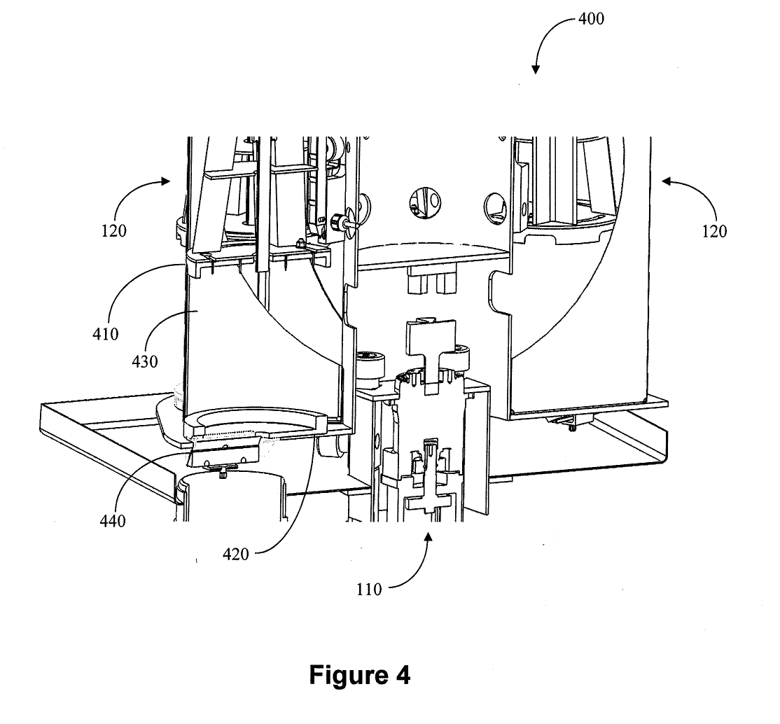

FIG. 4 illustrates a sectional close-up view of a lower portion 400 of the apparatus 100. FIG. 4 illustrates the carousel 110 which is encircled by the plurality of frozen block shaving units 120. Each shaving unit 120 includes a hopper 430, located on a lower portion of the shaving unit 120. The hopper 430 is located between a top plate 410 and a lower shaver plate 420, where the frozen blocks are loaded. The shaving unit 120 further includes a blade assembly 440, which is configured to shave the frozen blocks and is located beneath the hopper 430.

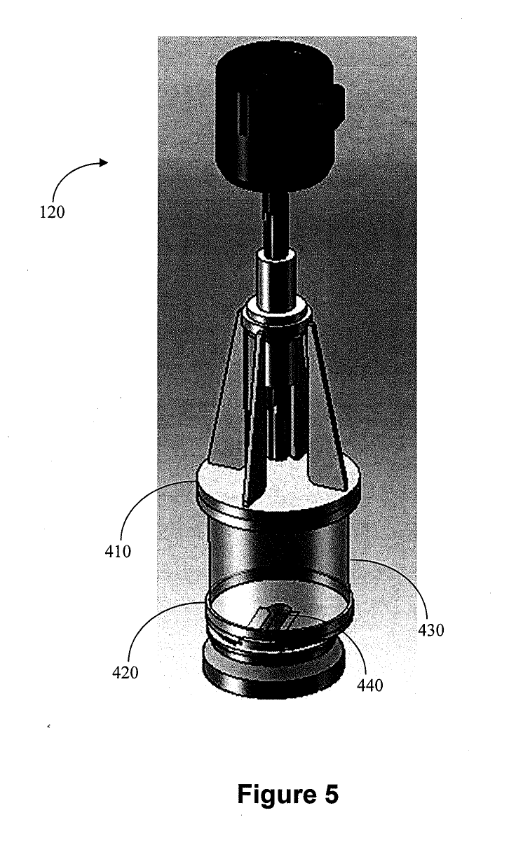

FIG. 5 is a perspective view of a shaving unit 120, which is located within the carousel 110 of the apparatus 100. A frozen block is placed in the hopper 430 between the top plate 410 and the lower shaver plate 420. The frozen block is pressed downward by the top plate 410 and spun such that the base of the frozen block is shaved by a blade assembly 440 protruding from or through the lower shaver plate 420 and shaved frozen block products are produced. In some cases, the top plate 410 includes pins or spikes located on the plate and configured to hold the frozen block in place. It will be understood that the location of individual pins may by randomly positioned throughout the top plate 410 or may be located in a specific pattern, for example, concentric circles, regular intervals, or the like.

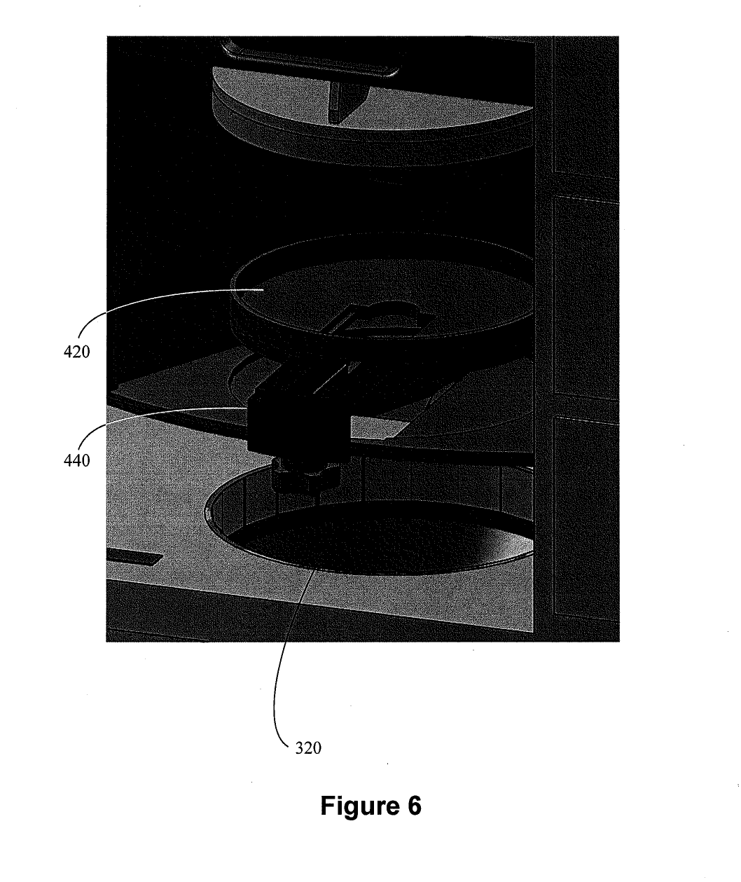

FIG. 6 is a close-up perspective view of a shaver area of the apparatus 100 illustrating the dispenser 320 and the shaving area within the shaving unit 120. FIG. 6 illustrates the blade assembly 440 with the lower shaver plate 420. It is intended that the blade rises above the lower shaver plate 420, which will shave the frozen block. The blade assembly 440 can be easily removed from the lower shaver plate 420 in order to be accessible for cleaning, maintenance or replacement. In some cases, the blade assembly 440 may be fixed to the lower shaver plate 420 such that both elements are removable and may be cleaned together.

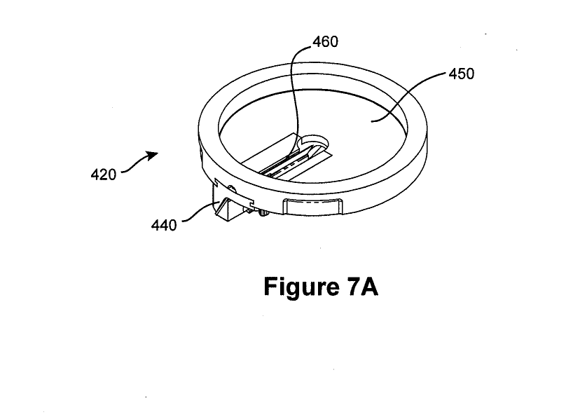

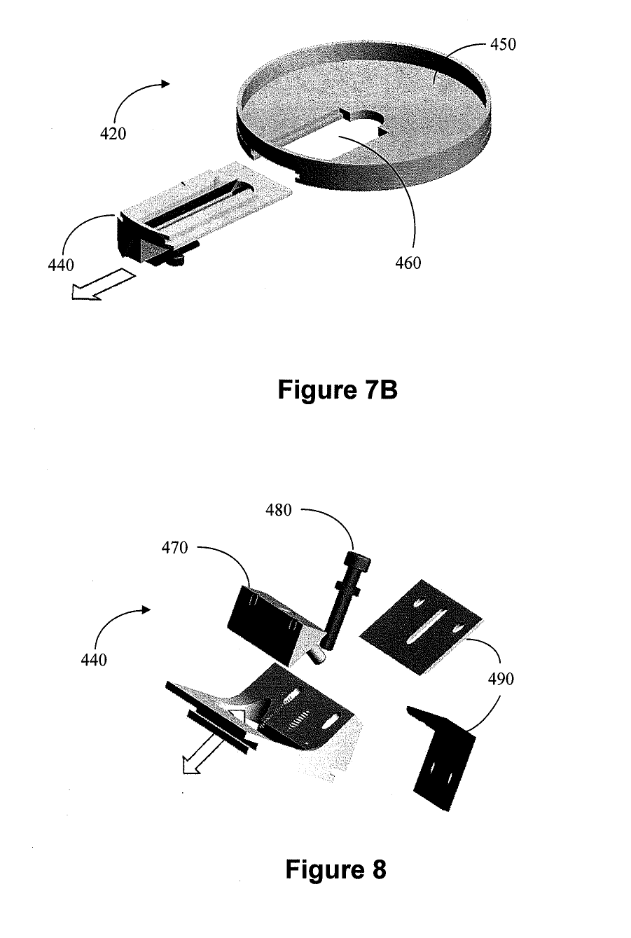

FIG. 7A is a perspective view of a lower shaver plate 420. The lower shaver plate 420 includes a plate 450, an aperture 460 located on the plate 450 which is intended to allow ice shavings to fall through the aperture 460. The lower shaver plate is removably connected to the blade assembly 440 which is intended to be received by the aperture 460.

FIG. 7B illustrates the modular blade assembly 440 detached from the lower shaver plate 420. The removability feature is intended to allow for easy access to cleaning of the blade assembly 440 and for the blade assembly 440 to be repaired and replaced as needed. In some cases, the blade assembly 440 may include storage for a plurality of blades in order to reduce the need to replace the blade assembly 440. In some cases, the blade assembly 440 slidably slots on the lower shaver plate 420. The lower shaver plate 429 may include a clamping mechanism configured to lock the blade assembly 440 in place.

FIG. 8 is an exploded perspective view of a blade assembly 440. In this case, the blade assembly 440 is configured such that a blade 470 is secured in the blade assembly 440 by a fastener 480 for example, a thumb screw, or the like. Further adjusting plates 490 may also be included in the blade assembly 440 and may be used to position the blade 470 and or blade assembly 440 in connection with the lower shaver plate 420. This configuration is intended to allow for easy assembly and disassembly in order to clean, repair and replace the elements of the blade assembly 440. In some cases the blade 470 may be heat treated to attain a harder surface. In some cases, the blade 470 may be lowered, raised or otherwise manipulated to allow for shaving with varying thickness and texture.

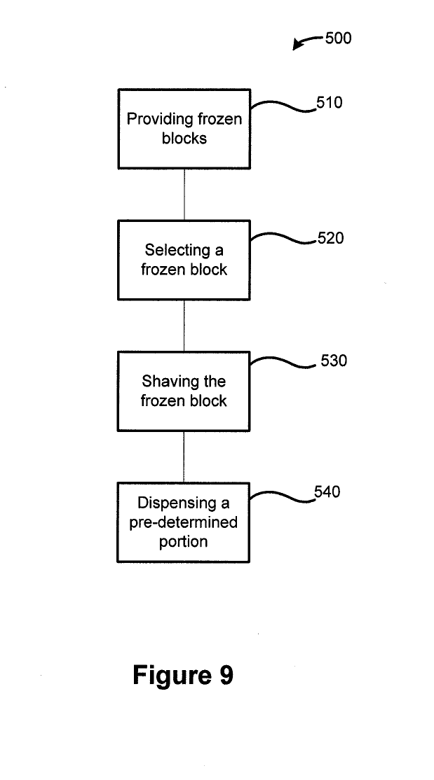

FIG. 9 illustrates a method to store and dispense shaved frozen products 500 according to an embodiment. At 510, the method includes providing at least one frozen blocks to the shaving units 120 of the apparatus 100. The apparatus 100 is configured to contain the frozen blocks at a regulated temperature within a refrigerated area. The apparatus is further configured to periodically determine the temperature of the refrigerated area, for example, every minute, every hour, ever day, or the like. If the temperature of the refrigerated area is outside a predetermined threshold, the apparatus 100 may issue an alert. The alert may be an audible or visual or combination of an audible or visual alert and is intended to alert an operator of that the temperature of the refrigerated area is outside of the predetermined threshold. In some cases, the temperature of the frozen blocks may be monitored as opposed to or in addition to the temperature of the refrigerated area.

At 520, a selection of at least one of the plurality of frozen blocks is made. The selection may be completed by a user through using a user selection button 130 or may be selected through another input option. At 530, the frozen block is shaved by the blade assembly 440 located within the shaving unit 120. At 540, the apparatus 100 dispenses a predetermined portion of the selected one of the frozen blocks. The predetermined portion may be based on a predetermined duration of shaving, a predetermined number of revolutions of the shaving sub-assembly, a predetermined reduction of volume of the frozen block, or the like. In some cases, the apparatus 100 is designed to dispense more than one flavor of frozen blacks with a single selection and without the need to manually change the frozen blocks between flavors.

In some case, the method may further include issuing an alert that the quantity of at least one of the frozen blocks is low or finished. The warning may be, for example, an exterior light, a displayed message, a sound emitted through a speaker in the apparatus, or the like, a combination of the possible warnings. In some cases, the warning may include further information as to which of the plurality of frozen blocks is low or finished.

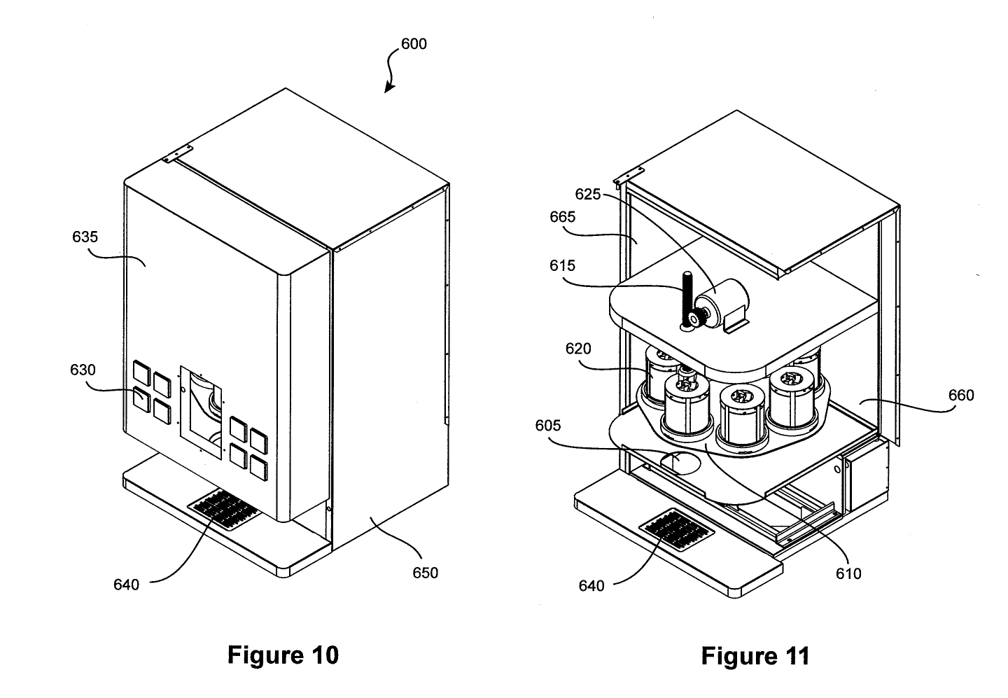

FIG. 10 illustrates another embodiment of an apparatus for dispensing shaved frozen products 600. The apparatus 600 includes a plurality of user selection buttons 630 located on a door 635 of the apparatus 600. The door 635 is designed to allow easy access to the interior of the apparatus 600 and may further include a locking mechanism (not shown) where, for example, the apparatus is designed for commercial self service. The apparatus further includes a dispensing tray 640 designed to receive a receptacle (not shown) and a cover 650.

FIG. 11 illustrates a front perspective view of the interior of the apparatus 600 of FIG. 10. The apparatus includes a plurality of shaving units 620 located on a carousel 610. The carousel 610 and the plurality of shaving units 620 are located within a refrigerated section 660 of the apparatus 600. An electrical section 665 is located above and separate from the refrigerated section and is designed to store the electronic components of the apparatus.

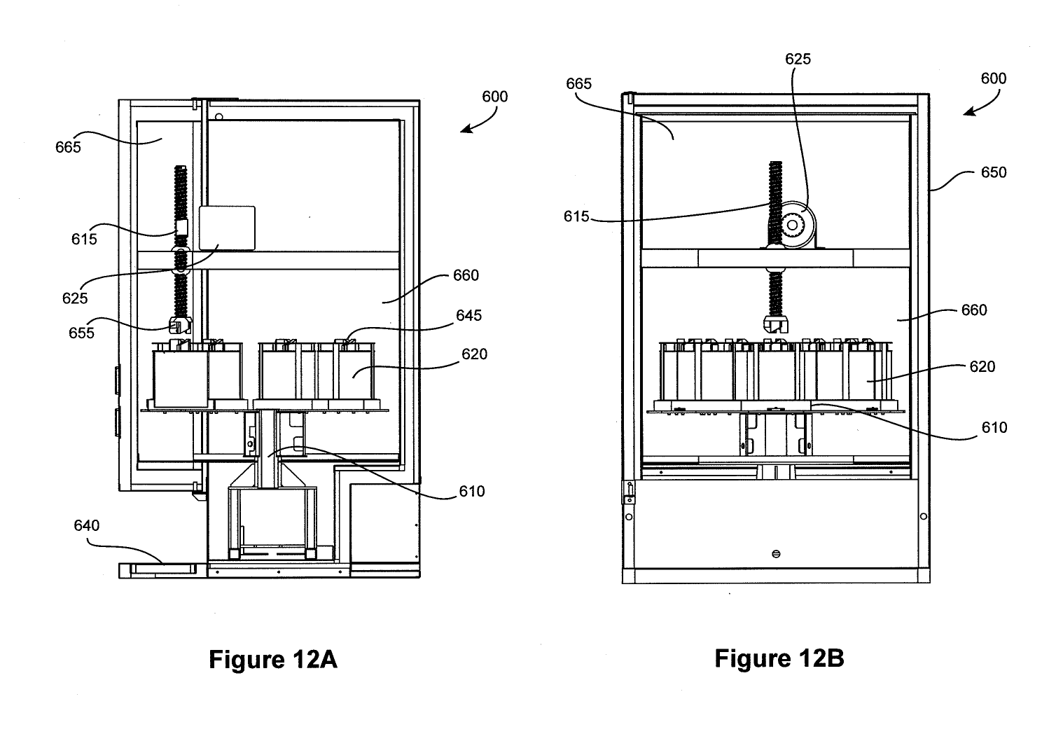

FIG. 12A illustrates a side view of the interior of the apparatus 600 while FIG. 12B illustrates a front view of the apparatus 600 of FIG. 10. The apparatus 600 includes a motor 625 designed to drive a shaft 615. The shaft 615 includes an end 655 adapted to receive a correspondingly configured top 645 of each shaving unit 620 of the plurality of shaving units. Once the end 655 of the shaft 615 has connected with the top of the shaving unit 620, the shaft 615 rotates in order to rotate the shaving unit 620 which allows the blade assembly within each shaving unit to shave the frozen block. In some cases, the shaft 615 rotates a fixed number of times in order for the amount of shaven frozen block to remain consistent through a plurality of servings. In other cases, the operator of the machine may select a desired amount of frozen product and the shaft 615 may rotate in order to dispense the corresponding amount of frozen product.

The apparatus 600 is further configured to align the selected shaving unit 620, containing the flavor requested through the selection input, with a dispensing area 605 located above the dispensing tray 640. The apparatus 600 rotates the carousel 610 in order to align the shaving unit 620 with the dispensing area 605. In some cases, the apparatus 600 may move the carousel 610 in a forwards or backwards motion to align the shaving unit 620 with the dispensing area 605. In some case, the motor 625 may provide the power to rotate the carousel. In other cases, a separate motor (not shown) may be used to drive the carousel.

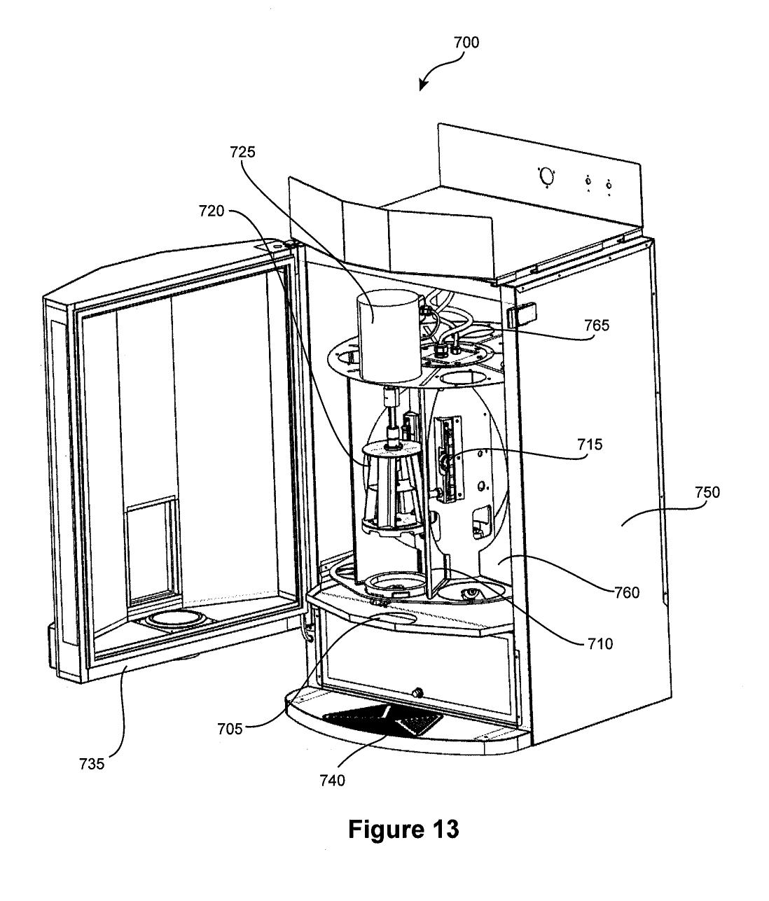

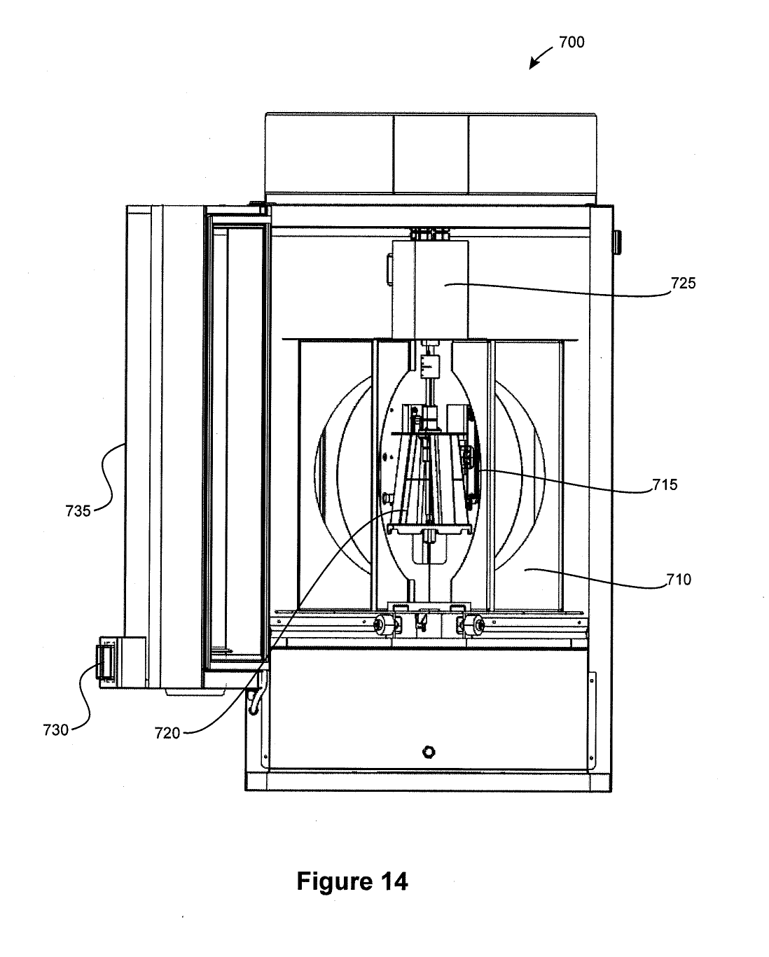

FIGS. 13 to 15 illustrate an alternative embodiment of an apparatus for dispensing frozen products 700. The apparatus includes a carousel 710 adapted to receive a plurality of shaving units 720. Although a single shaving unit 720 is shown, it will be understood that the carousel 710 is able to receive a plurality of shaving units 720 located in a circular arrangement around the carousel 710.

An electronic section 765 is located within the carousel 710. The electronic section may include a motor 725 designed to drive a shaft 715, which is configured to connect to each shaving unit 720 to allow for the shaving of the frozen block. In some cases, each shaving unit 720 may be connected to a separate shaft 715 which may be driven by a separate motor. In other cases, a single shaft 715 may be used and the shaft 715 may be configured to engage the shaving unit 720 corresponding to the user selection. The carousel 710 is further configured to rotate to allow for the selected shaving unit 720 to align with a dispensing area 705 located above a dispensing tray 740.

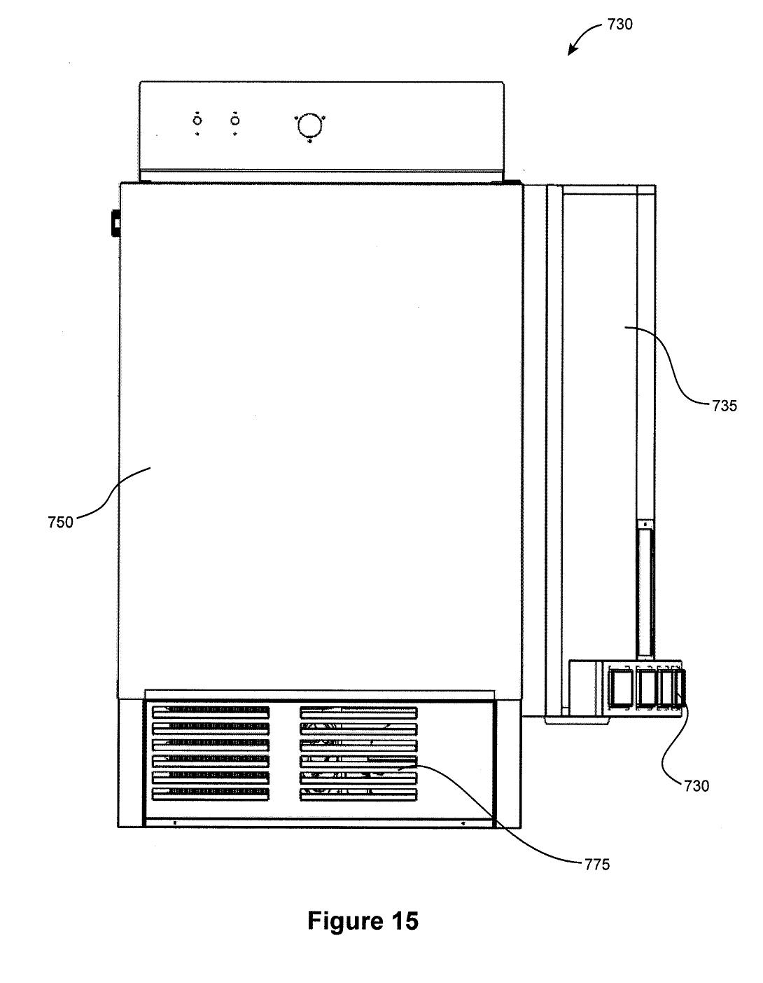

The apparatus 700 further includes a cover 750 connected to a door 735. The door may include a plurality of user selection buttons 730. As shown in FIG. 15, the back of the cover 750 may include a vent 775.

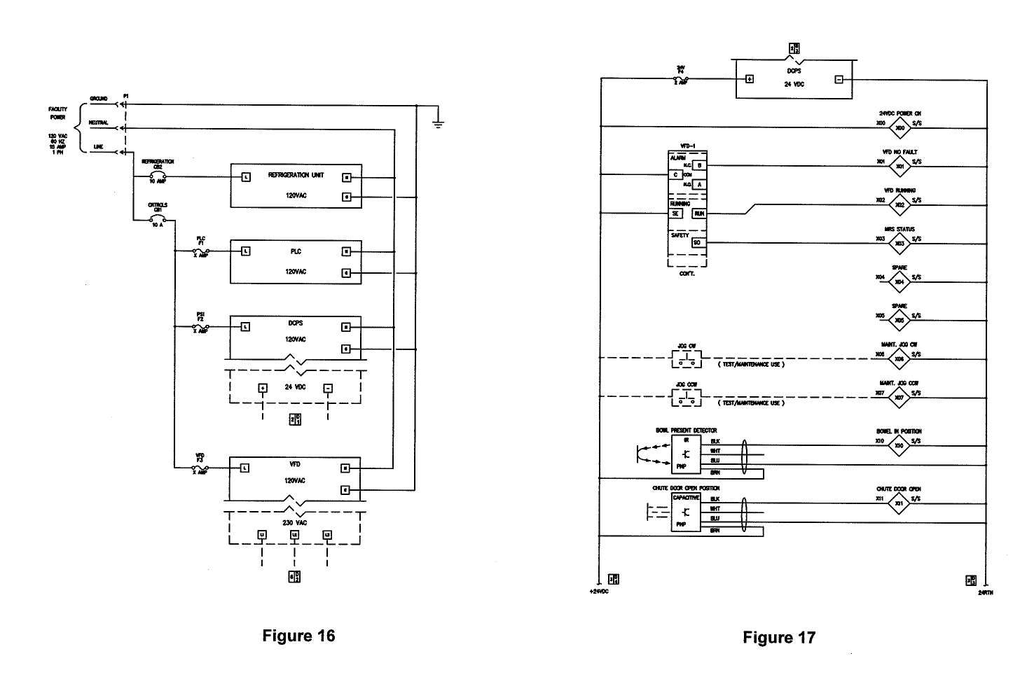

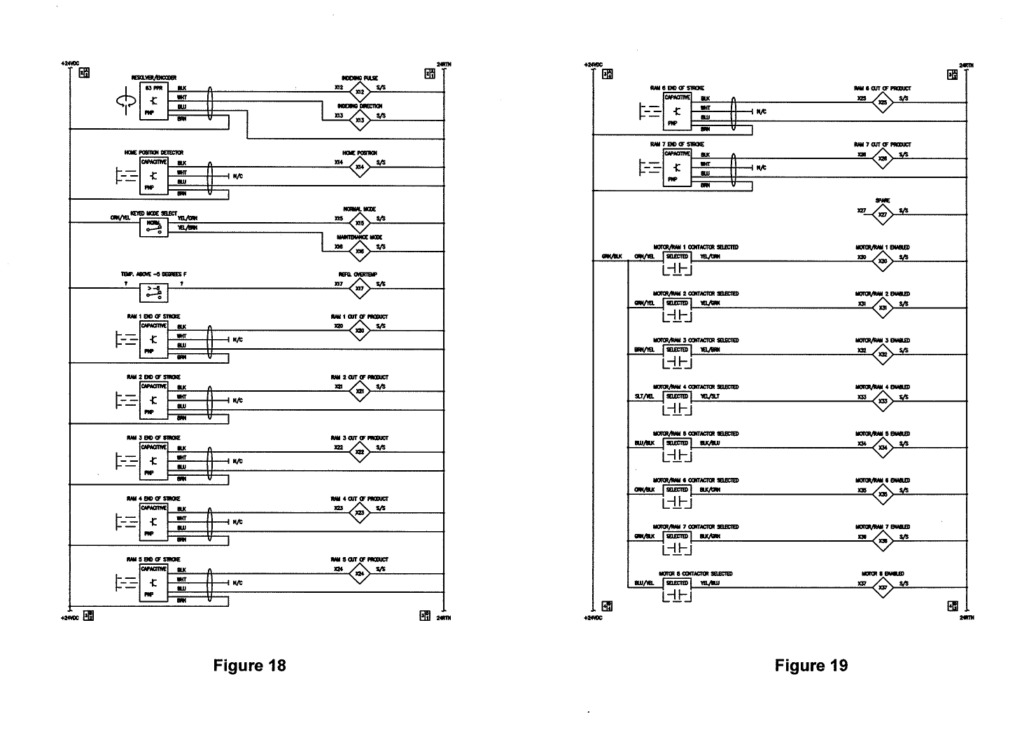

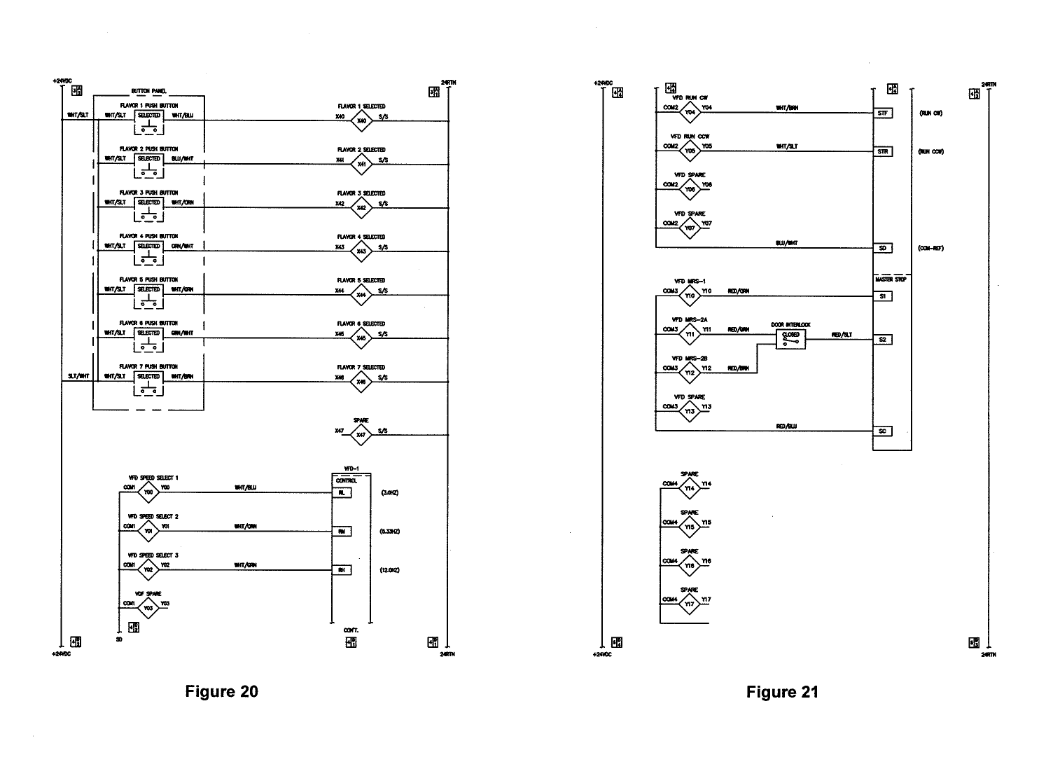

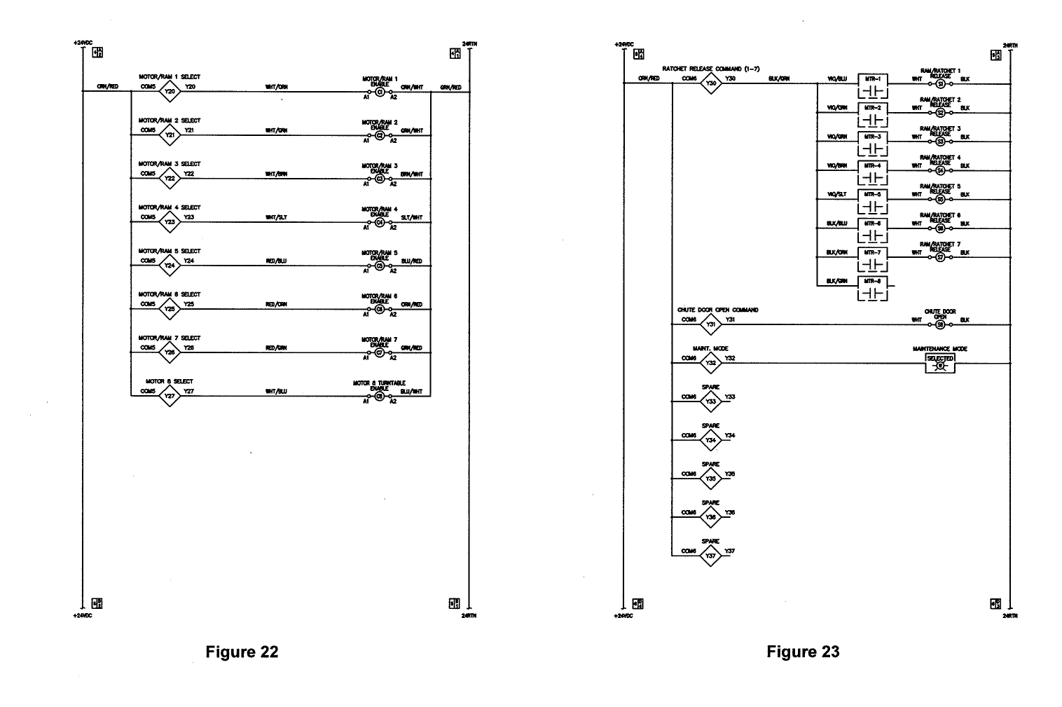

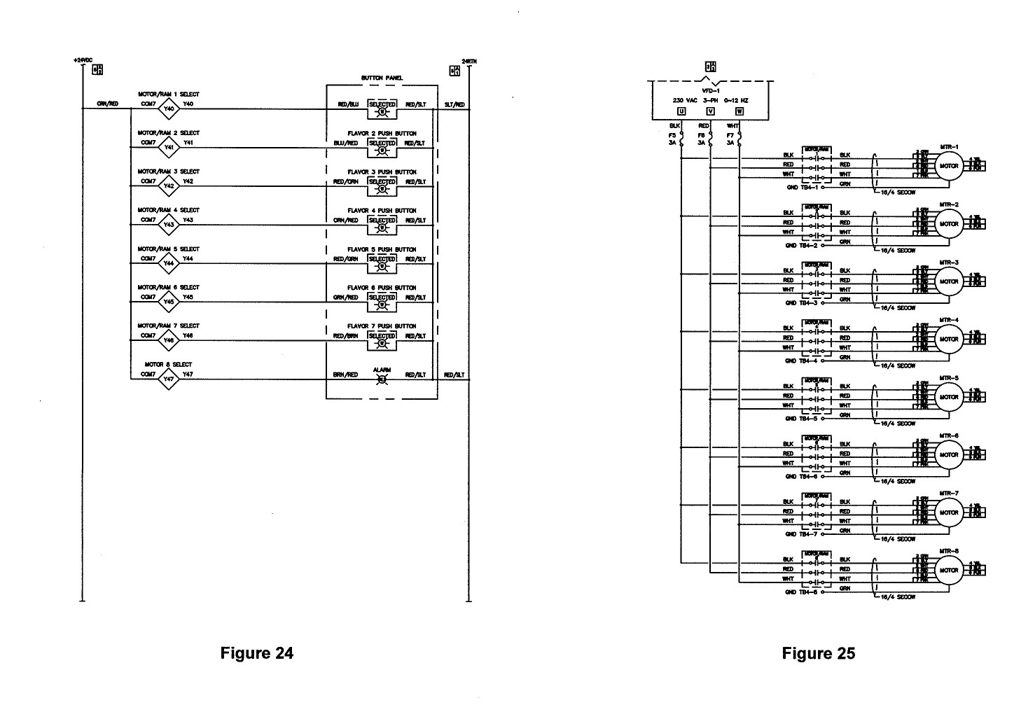

FIGS. 16 to 25 illustrate various electronic circuits in relation to the control and operations on an apparatus for dispensing frozen product, such as in the previously described embodiments.

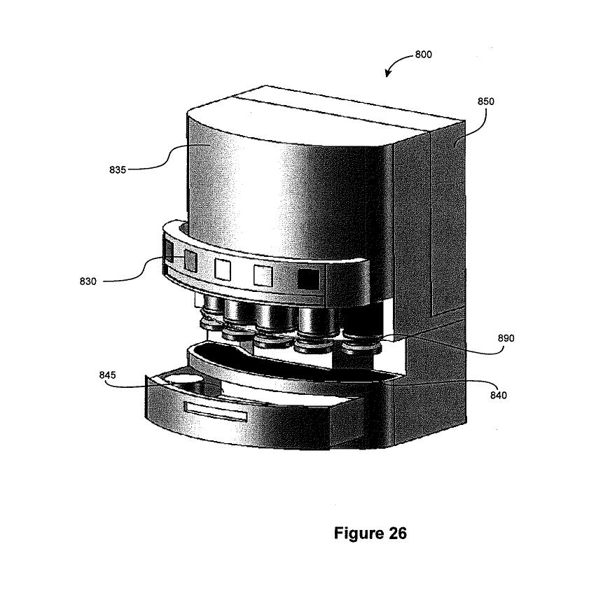

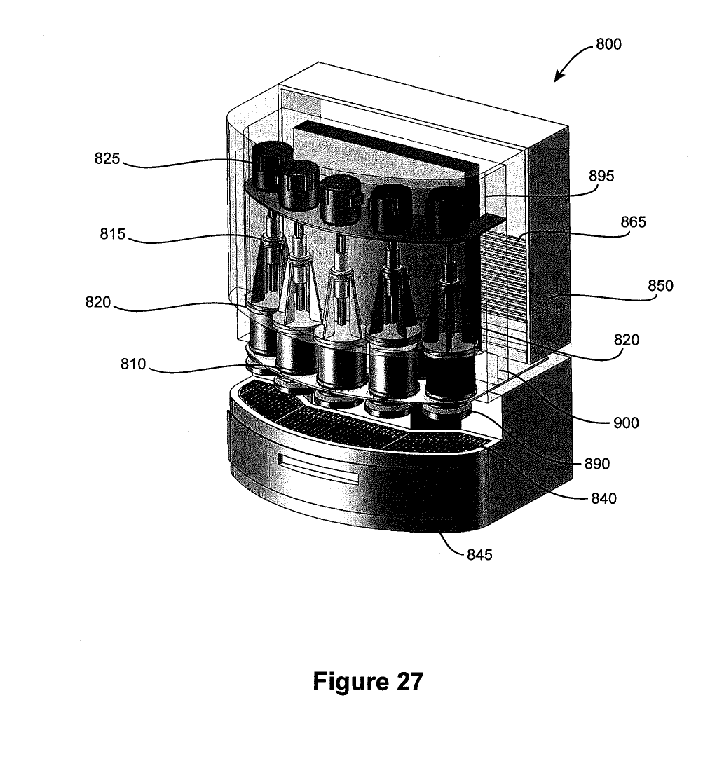

FIGS. 26 to 28 illustrate another alternative of an apparatus for dispensing frozen products 800. The apparatus 800 includes a cover 850 and a door 835 which is configured to open to allow access to the elements within the cover. The apparatus 800 may further include user selection buttons 830 which may allow for the dispensing of a specific flavor of frozen product. In some cases, each user selection button 830 may trigger the dispensing of a frozen product aligned with and operatively connected to the user selection button 830. The apparatus 800 may include a plurality of removable funnels 890, operatively connected to each of a plurality of shaving units 820. Each funnel 890 may be designed to allow for the frozen product to be directed into a receptacle and may be further configured to rotate or otherwise move while dispensing the frozen product to allow for the product to be dispensed evenly into the receptacle.

In this embodiment, the dispensing tray 840 may be elongate as each of plurality of shaving units 820 may dispense the frozen product over a separate dispensing area 805. The apparatus 800 may further include a storage drawer 845. In some cases the drawer 845 may be a refrigerated drawer designed to keep additional frozen blocks prior to the blocks being provided to a shaving unit 820.

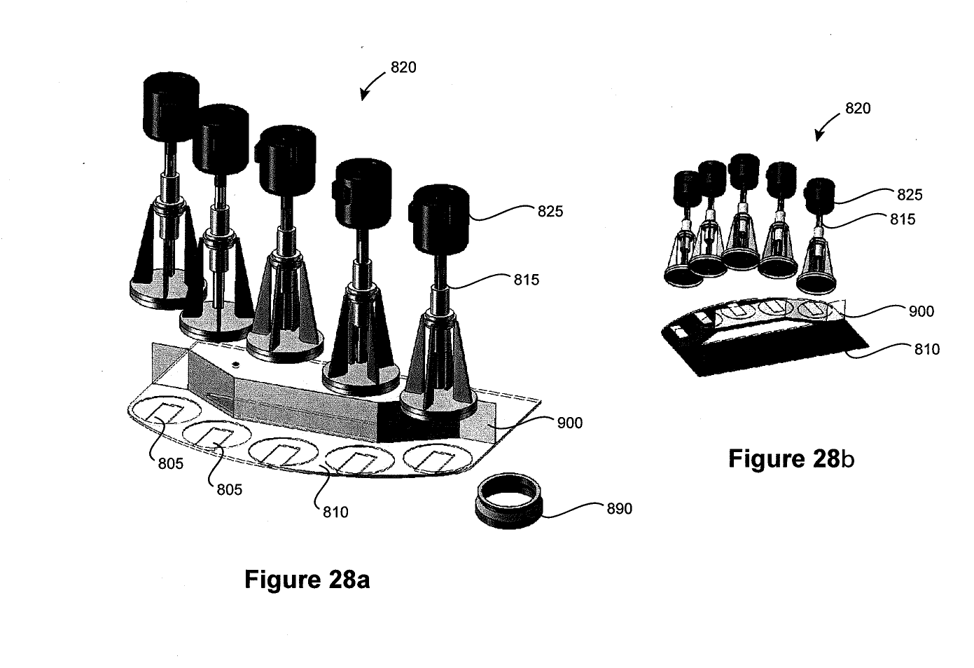

In this embodiment, the apparatus 800 includes a platform 810 designed to hold each shaving unit 820 in a linear or crescent formation. The platform 810 is stationary and is designed to align each shaving unit 820 above a dispensing area 805 as can be seen in FIGS. 28A and 28B. Each shaving unit 820 includes a motor 825 operatively connected to a drive shaft 815 designed to rotate the shaving unit 820 with the frozen product against a blade assembly. The apparatus 800 may further include a splash guard 900 which is intended to allow for easy cleaning.

The apparatus includes a chiller plate 895 which is intended to chill the refrigerated area including the frozen product area and the storage drawer 845. The apparatus 800 may include an electronic area 865 which may not be cooled and may encase a compressor and electronic controls.

The embodiments of the apparatus described herein are intended to dispense frozen product into one or more receptacles and to allow selection of at least one of a plurality of flavors to be dispensed, which is intended to allow for high volume output. It is further intended that the apparatus allows the setting of portions and portion controls at a variety of desired levels and may be further adapted to lock and unlock the portion setting, as a user defined portion control feature.

The apparatus may further provide enhanced shaving speed control, which is adapted specifically for frozen products. The apparatus may also include an improved blade design over traditional blade designs as traditional designs may not include the ability to adjust the blade to vary the texture and/or thickness of the shaved frozen product. The blade and blade assembly are further intended to be easily removed to clean without disassembly.

The embodiments of the apparatus are intended to have a modular maintenance design, that is adapted for ease and speed of repairs and for modular replacement parts, which is intended to reduce “out of service” time that may be required when maintaining the apparatus.

The apparatus may further include a storage option for additional frozen blocks and is also intended to maintain a desired storage temperature within a refrigerated area. The refrigerated area is intended to be easily accessed to allow access to the stored product for re-loading, which is intended to enhance high volume production loading.

It is further intended to provide an apparatus which maintains the desired temperature range for the loaded frozen blocks, which are loaded in a shaving unit, while the apparatus is in an active dispensing mode, and while the apparatus is in a dispensing-ready mode (or stand-by mode).

In the preceding description, for purposes of explanation, numerous details are set forth in order to provide a thorough understanding of the embodiments. However, it will be apparent to one skilled in the art that these specific details may not be required. In other instances, well-known structures are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. An apparatus for dispensing shaved frozen product comprising:
a dispensing area; and
a refrigerated area comprising:
a plurality of shaving units; and
a platform, operatively connected to each of the plurality of shaving units and configured to allow each shaving unit to rotate.

2. The apparatus of claim 1, further comprising:
a cover comprising a plurality of user selection input options.

3. The apparatus of claim 1, further comprising:
an electronic area comprising:
at least one drive shaft configured to connect to at least one shaving unit of the plurality of shaving units; and
at least one motor operatively connected to the at least one drive shaft and configured to rotate the shaving unit to shave the frozen product.

4. The apparatus of claim 3, wherein the refrigerated area and the electronic area are distinct areas within the apparatus.

5. The apparatus of claim 1, wherein each shaving unit comprises:
a top plate;
a lower shaver plate; and
a hopper located between the top plate and lower shaver plate.

6. The apparatus of claim 5, wherein the top plate comprises a plurality of pins configured to grip the frozen product.

7. The apparatus of claim 1, wherein each shaving unit comprises a lower shaver plate comprising a blade assembly.

8. The apparatus of claim 7, wherein the blade assembly comprises a removably attached blade.

9. The apparatus of claim 7, wherein the blade assembly slidably slots on the lower shaver plate comprising a clamping mechanism configured to lock the blade assembly in place.

10. The apparatus of claim 7, wherein the blade assembly comprises a heat treated blade.

11. The apparatus of claim 1, wherein the platform is a carousel configured to rotate the plurality of shaving units.

12. A method for storing a shaved frozen product comprising:
providing a plurality of frozen blocks to a plurality of shaving units; and
regulating the temperature within a refrigerated component housing the plurality of shaving units.

13. The method of claim 12, further comprising
determining whether the regulated temperature is outside of a predetermined threshold; and
if the temperature is outside of the predetermined threshold, providing an alert, otherwise continuing to regulate the temperature.

14. A method for dispensing a shaved frozen product comprising:
providing a plurality of frozen blocks to a plurality of shaving units;
selecting at least one of the frozen blocks to be shaved;
rotating a carousel to align a shaving unit of the plurality of shaving units with a dispensing area; and
dispensing a predetermined portion of the selected frozen block.

15. The method of claim 14 wherein dispensing a predetermined portion of selected frozen block comprises shaving the frozen block.

16. The method of claim 14 wherein a predetermined portion is based on a predetermined duration of shaving or a predetermined number of revolutions of the frozen block within the shaving unit.

17. The method of claim 14, wherein selecting at least one of the frozen blocks to be shaved comprises, selecting a plurality of frozen blocks to be shaved; and
dispensing a predetermined portion of the selected frozen block comprises, dispensing a predetermined portion of each of the selected frozen blocks.

18. The method of claim 14, further comprising:
determining the amount of frozen block within each shaving unit; and
issuing an alert if the amount of frozen block is below a predetermined threshold.
